(19) United States
(12) Patent Application Publication
(10) Pub. No.: US 2025/0332896 A1
(43) Pub. Date: Oct. 30, 2025

(54) WEATHER STRIP

(71) Applicant: TOKAI KOGYO CO., LTD., Obu-shi (JP)

(72) Inventors: Kiyotaka WASHINO, Obu-shi (JP); Keiji Hiroe, Obu-shi (JP)

(73) Assignee: TOKAI KOGYO CO., LTD., Obu-shi (JP)

(21) Appl. No.: 19/082,598

(22) Filed: Mar. 18, 2025

(30) Foreign Application Priority Data
Apr. 26, 2024 (JP) 2024-073254

(51) Int. Cl. B60J 10/16; B29C 48/00; B29C 48/16; B29K 23/00; B29L 31/26; B60J 10/80

(52) U.S. Cl. CPC B60J 10/16; B29C 48/0012; B29C 48/16; B60J 10/80; B29K 2023/16; B29L 2031/26

(57) ABSTRACT

A method for producing a weather strip, the weather strip having a seal portion that is configured to be sandwiched between a periphery of a car body opening part and a door body capable of closing the car body opening part and seal a space therebetween, the seal portion including a base layer that forms a shape of the seal portion and a surface layer that covers at least a part of an outer surface of the base layer, the base layer being comprised of a rubber foam obtained by causing a composition for a base layer containing a foaming agent and a rubber material to foam, the surface layer being comprised of a resin foam obtained by causing a composition for a surface layer containing a foaming agent and a resin material to foam.

### CROSS-REFERENCE TO RELATED APPLICATIONS

This application is based on and claims priority under 35 USC 119 from Japanese Patent Application No. 2024-073254 filed on Apr. 26, 2024, the entire content of which is incorporated herein by reference.

### TECHNICAL FIELD

The present invention relates to a weather strip, which has a seal portion that is configured to be sandwiched between a periphery of a car body opening part and a door body capable of closing the car body opening part and seal a space therebetween, in particular, a weather strip in which a surface layer is laminated on the seal portion, and a method for producing the same.

### BACKGROUND ART

Examples of such a weather strip are discussed in the following Patent Literatures 1 and 2. In a seal portion (seal portion 40) in Patent Literature 1, an outer surface of a base layer (elastic portion 42) formed of a foamed rubber material is covered with a surface layer (protective layer 44) formed of a non-foamed rubber material. In Patent Literature 1, the base layer and the surface layer are laminated in an extrusion molding step of simultaneously co-extruding a composition for a base layer and a composition for a surface layer. And the base layer is foamed and vulcanized in a heating step of heating a weather strip intermediate extruded in the extrusion molding step. In this case, foaming of the foaming agent in the base layer may cause unevenness caused by the foaming on the outer surface of the base layer, but since the unevenness is covered with the surface layer, an outer surface of the seal portion becomes smooth, and wear resistance thereof is also improved by presence of the surface layer.

In Patent Literature 2, surface layers (fine-foamed sponge rubber coatings 34) formed of fine-foamed sponge rubber having a specific gravity of 0.9 to 1.1 are laminated on a surface of a base layer (sponge rubber layer 33) of a seal portion (hollow seal portion 32) formed of sponge rubber. In Patent Literature 2, an object thereof is to provide a weather strip that has wear resistance and is excellent in appearance of a seal portion that is provided with a corner part of a car body panel by laminating the surface layer for avoiding a situation in which, when the weather strip is to be attached to the corner part, the seal portion is not uniformly deformed and generates wrinkles and the appearance deteriorates.

### CITATION LIST

### Patent Literature

Patent Literature 1: JP2003-104134A
Patent Literature 2: JPH09-2072A

### SUMMARY OF INVENTION

In Patent Literature 1, since the surface layer is comprised of the non-foamed rubber material, foaming gas generated when the base layer is foamed can be prevented by the surface layer. However, since the seal portion is in pressure contact with a car body panel and a door body, it is necessary to prevent the seal portion from being adhered to the counterpart members, but the rubber material is poor in adhesion resistance. Therefore, in order to provide the seal portion with the adhesion resistance, the surface layer may be formed using a resin material. Since the resin material is softened by heat in the extrusion molding step and has a lower viscosity than that of the rubber material, the foaming gas generated by the foaming of the base layer cannot be prevented. In addition, in a non-foamed resin material, there is no escape portion (escape way) for the foaming gas from the base layer, and the foaming gas retains at an interface between the base layer and the surface layer. As a result, appearance and a sealing property of the surface layer and the seal portion may deteriorate.

The surface layer of Patent Literature 2 is comprised of the fine-foamed sponge rubber, but since the surface layer is finely foamed and has a relatively high specific gravity of 0.9 to 1.1, it is considered that cells in the surface layer are not open cells, in which adjacent cells communicate with each other, but are closed cells, in which respective cells are independent of each other. Therefore, also in Patent Literature 2, the foaming gas generated from the base layer cannot be released (discharged) to the outside through the surface layer.

Aspect of non-limiting embodiments of the present disclosure relates to providing a method for producing a weather strip having a seal portion in which a base layer and a surface layer comprised of a resin material are laminated, the method being capable of releasing foaming gas generated from the base layer to the outside through the surface layer in a process of producing the weather strip, and a weather strip having a good appearance obtained therefrom.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, the followings are provided.

<1> A method for producing a weather strip,
the weather strip having a seal portion that is configured to be sandwiched between a periphery of a car body opening part and a door body capable of closing the car body opening part and seal a space therebetween,
   the seal portion including a base layer that forms a shape of the seal portion and a surface layer that covers at least a part of an outer surface of the base layer,
      the base layer being comprised of a rubber foam obtained by causing a composition for a base layer containing a foaming agent and a rubber material to foam,
      the surface layer being comprised of a resin foam obtained by causing a composition for a surface layer containing a foaming agent and a resin material to foam,
   the method including:
   extrusion molding of simultaneously co-extruding the composition for a base layer and the composition for a surface layer; and
   heating of a weather strip intermediate extruded in the extrusion molding step, in which
   the foaming agent in the composition for a surface layer is caused to foam in the extrusion molding, and
   the foaming agent in the composition for a base layer is caused to foam in the heating.
      <2> The method for producing a weather strip according to <1>, in which
the composition for a surface layer contains 0.1 parts by weight to 3 parts by weight of the foaming agent with respect to 100 parts by weight of the resin material.
   <3> The method for producing a weather strip according to <1> or <2>, in which
the rubber material in the composition for a base layer is an ethylene propylene diene copolymer, and
the resin material in the composition for a surface layer is an olefin-based thermoplastic elastomer.
   <4> The method for producing a weather strip according to any one of <1> to <3>, in which
the composition for a surface layer contains a silicone oil.
   <5> The method for producing a weather strip according to any one of <1> to <4>, in which
the foaming agent in the composition for a surface layer is a chemical foaming agent.
   <6> A weather strip, which has a seal portion that is configured to be sandwiched between a periphery of a car body opening part and a door body capable of closing the car body opening part and seal a space therebetween, in which
the seal portion includes a base layer that forms a shape of the seal portion and a surface layer that covers at least a part of an outer surface of the base layer,
   the base layer is comprised of a rubber foam body obtained by causing a rubber material to foam,
   the surface layer is comprised of a resin foam body obtained by causing a resin material to foam, and
   the surface layer includes open cells, in which adjacent cells communicate with each other.
      <7> The weather strip according to <6>, in which
the surface layer contains a silicone oil.

In the present description, “AA to BB” indicating a numerical range means “AA or more and BB or less” unless otherwise specified.

According to <1> and <6>, since the surface layer is comprised of the resin material, the adhesion resistance thereof is better than that of a case where the surface layer is comprised of the rubber material, and adhesion of the seal portion to the counterpart members such as the door body can be avoided. In addition, when the surface layer is first caused to foam and cells in the surface layer are open cells, a communication path that communicates from a back surface to a front surface is formed in the surface layer. That is, a communication path extending from a base layer side to the outside is formed in the surface layer. As a result, foaming gas subsequently generated from the base layer can be released (discharged) to the outside through the surface layer, so that the foaming gas does not retain between the base layer and the surface layer, and a weather strip having a good appearance can be produced.

When both the base layer and the surface layer are foams, a weight of the weather strip can be further reduced.

According to <2> and <5>, it is possible to easily make the cells in the surface layer open cells.

According to <3>, it is possible to ensure good bonding strength between the base layer and the surface layer while ensuring elasticity in the base layer.

By adding any additive to the surface layer, it is possible to impart any function to the surface layer and improve physical properties thereof. For example, according to <4> and <7>, in addition to further improving the adhesion resistance of the surface layer, slipperiness thereof is also improved to prevent the seal portion from being worn even when the seal portion is rubbed.

### BRIEF DESCRIPTION OF DRAWINGS

Exemplary embodiment(s) of the present invention will be described in detail based on the following figures, wherein:

FIG. 1 is a schematic side view of a vehicle;

FIG. 2 is a cross-sectional view taken along a line II-II in FIG. 1;

FIG. 3 is a cross-sectional view of a weather strip;

FIG. 4 is a cross-sectional view taken along a line IV-IV in FIG. 2;

FIG. 5 is a schematic diagram showing a producing process;

FIG. 6 is an appearance photograph of Example 1;

FIG. 7 is an appearance photograph of Example 2;

FIG. 8 is an appearance photograph of Comparative Example 1; and

FIG. 9 is an appearance photograph of Comparative Example 2.

### DESCRIPTION OF EMBODIMENTS

A weather strip of the present disclosure is a member that is sandwiched between a periphery of a car body opening part of a car body panel and a door body capable of closing the car body opening part to seal a space therebetween, and is a long member having a substantially uniform shape over the entire longitudinal direction by extrusion molding.

Examples of a place where such a weather strip is used include the periphery of the car body opening part such as a front door opening part, a rear door opening part, a trunk opening part, a back door opening part, and a roof opening part of a vehicle. Specifically, the weather strip can be used as a center pillar molding, a door seal, a door opening seal, a back door seal, a hood seal, or the like. The weather strip is attached in an annular shape to a flange forming the periphery of the car body opening part, the car body panel, a front door, a rear door, or the like so as to surround a part or the entire periphery of the car body opening part.

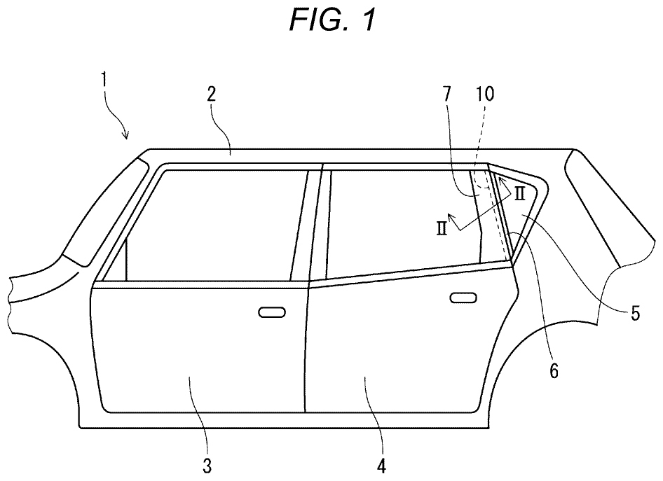

Hereinafter, an embodiment in which the weather strip is applied to a quarter window molding will be described as an example of the present invention. As illustrated in FIG. 1, in vehicle 1 such as an automatic vehicle, in a part of a car body panel 2, car body opening parts for a front door 3 and a rear door 4 are opened, and a car body opening part for a quarter window 5 is also opened. The car body opening parts for the front door 3 and the rear door 4 can be freely opened and closed by the front door 3 and the rear door 4, respectively. The quarter window 5 is fitted and fixed to the car body opening part for the quarter window 5 via a quarter window molding 6 disposed over the entire periphery of the car body opening part. The reference numeral 7 denotes a garnish for decoration.

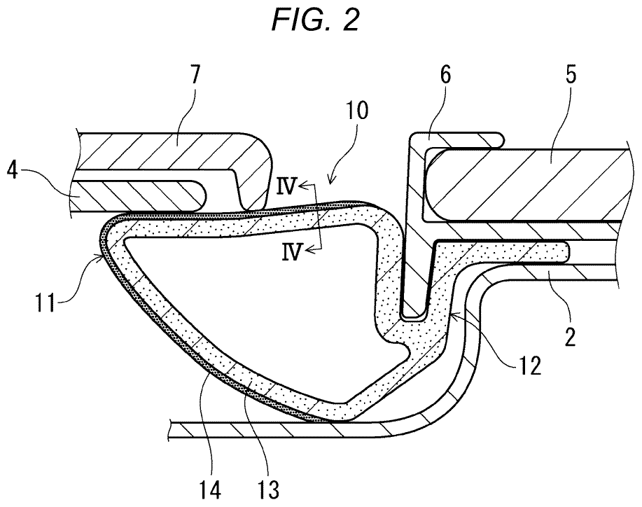

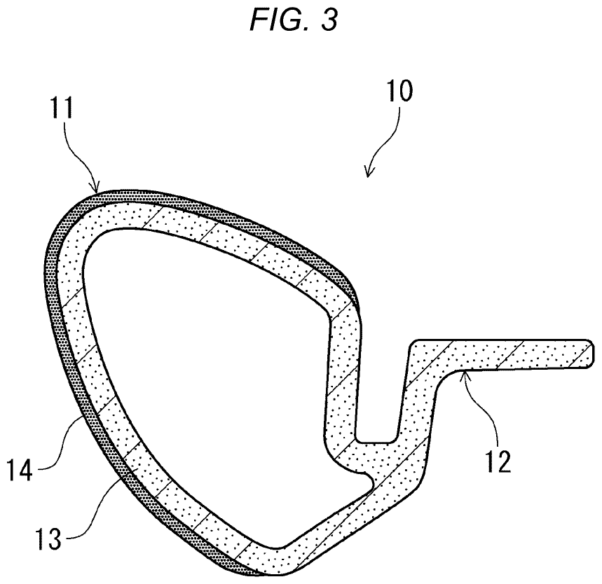

In addition, a weather strip 10 of the present embodiment is disposed along a rear door 4 side of the quarter window molding 6. As illustrated in FIGS. 2 and 3, the weather strip 10 integrally includes a seal portion 11 and an attachment portion 12. The attachment portion 12 is a plate-shaped part having a shape (horizontal L shape in cross section in the present embodiment) corresponding to a shape of a gap between the quarter window molding 6 and the car body panel 2, and the attachment portion 12 is sandwiched between the quarter window molding 6 and the car body panel 2 to allow the weather strip 10 be provided to a part of the periphery of the car body opening part of the car body panel 2.

The seal portion 11 is a hollow cylindrical part for facilitating elastic deformation, and is located closer to a side of the car body opening part for the rear door 4 than the quarter window molding 6. As a result, when the rear door 4 is closed, the seal portion 11 is pressed by the rear door 4, and a space between the car body panel 2 and the rear door 4 is sealed by the weather strip 10.

The seal portion 11 includes a base layer 13 forming a basic shape and a surface layer 14 covering at least a part of an outer surface of the base layer 13. Since the attachment portion 12 is comprised of the same material as that of the base layer 13, a description for the material of the base layer 13 is also used as a description of the material of the attachment portion 12. In the present embodiment, the surface layer 14 is laminated at least from a range in contact with the rear door 4 and the garnish 7 to a range in contact with the car body panel 2. The seal portion 11 includes only two layers of the base layer 13 and the surface layer 14, and other layers are not laminated, so that the elastic deformation of the seal portion 11 is not inhibited more than necessary, and a pressing force (compression load for pressing seal portion 11) at the time of closing the rear door 4 is designed to be as small as possible.

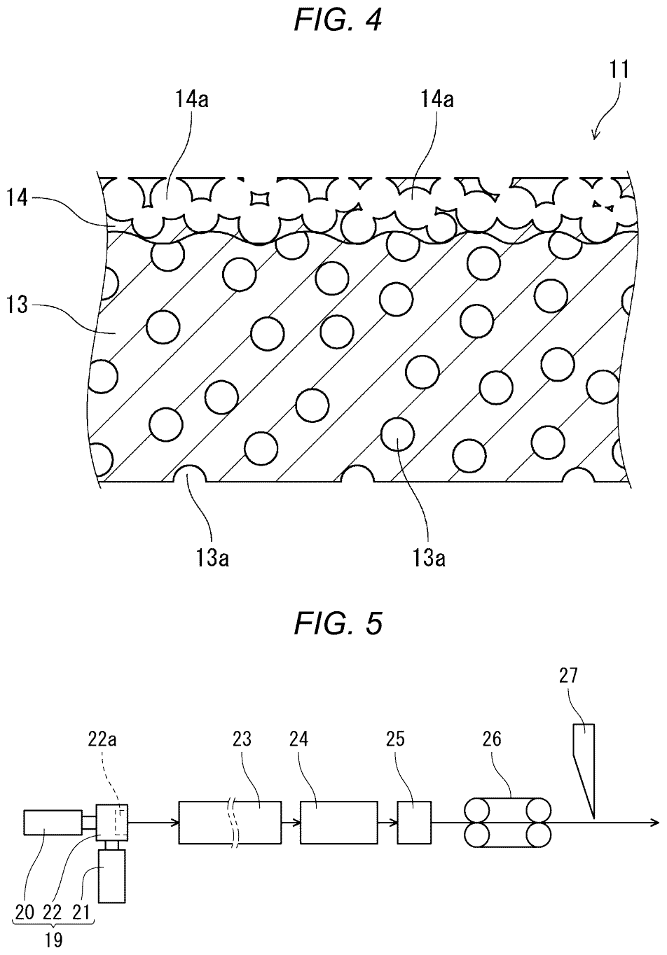

As illustrated in FIG. 4, the base layer 13 is comprised of a rubber foam having a plurality of cells 13a therein, which is obtained by causing a composition for a base layer containing a foaming agent in a rubber material to foam. The rubber material serving as a base material of the base layer 13 is not particularly limited, and a rubber material known in the related art can be used without particular limitation in this type of weather strip. Examples thereof include various kinds of rubber materials such as an ethylene propylene diene copolymer (EPDM), an ethylene propylene copolymer (EPM), a polychloroprene, a styrene-butadiene rubber (SBR), and an acrylonitrile-butadiene rubber (NBR). Among those, EPDM having good weather resistance and heat resistance is preferable. In addition, a polyolefin-based resin such as polyethylene or polypropylene may be added to these materials. For example, a polymer alloy containing polyethylene may be used with EPDM.

The foaming agent to be added to the composition for a base layer is not particularly limited, and a foaming agent known in the related art can be used without particular limitation in this type of weather strip. For example, a microcapsule or a pyrolytic chemical foaming agent can be used. Examples of the chemical foaming agent include azo compound-based (ADCA-based) chemical foaming agents, nitroso compound-based (DPT-based) chemical foaming agents, hydrazine compound-based (OBSH-based) chemical foaming agents, sodium bicarbonate-based chemical foaming agents, and composite chemical foaming agents thereof. Among those, the OBSH-based chemical foaming agent having a relatively low thermal decomposition temperature (about 160° C.) is preferable. In addition, two or more kinds of foaming agents may be added.

Since the base layer 13 as well as the attachment portion 12 are comprised of rubber foams, a weight of the entire weather strip 10 can be reduced, and it is necessary for the base layer 13 to ensure a constant shape retention strength. Therefore, a specific gravity of the base layer 13 is preferably 0.45 to 0.9, and more preferably 0.5 to 0.8. When the specific gravity of the base layer 13 is less than 0.45, there is a concern that the shape retention strength cannot be ensured. On the other hand, when the specific gravity exceeds 0.9, the weight of the entire weather strip 10 becomes large. In addition, a hardness of the base layer 13, particularly the attachment portion 12, is preferably a Shore A hardness scale of 30 degrees to 65 degrees. When the Shore A hardness scale is within this range, a holding force and durability of the attachment portion 12 are good.

A content of the foaming agent in the composition for a base layer is preferably 1.0 parts by weight to 3.5 parts by weight, and more preferably 2.0 parts by weight to 3.0 parts by weight with respect to 100 parts by weight of the rubber material. When the content of the foaming agent in the composition for a base layer is within this range, the specific gravity of the base layer 13 after molding can be set within the above range. On the other hand, when the content of the foaming agent in the composition for a base layer is less than 1.0 part by weight, a weight of the base layer 13 is not sufficiently reduced, and when the content of the foaming agent exceeds 3.5 parts by weight, an inside porosity becomes too high, and there is a concern that the elasticity and the shape retention strength are reduced. Here, as for the foaming agent in the composition for a base layer, a foaming agent is not directly added to the rubber material, and a master batch containing the foaming agent may be added, but the above content of the foaming agent indicates an amount of only the foaming agent.

The respective cells 13a formed inside the base layer 13 may be open cells, but it is preferable that a ratio of closed cells that are independent of each other (non-open) is high. This is because, when the respective cells 13a in the base layer 13 are closed cells, an amount of foaming gas generated during foaming of the composition for a base layer flowing toward a surface layer 14 side can be prevented as much as possible. A thickness of the base layer 13 may be within a general range in this type of weather strip in the related art, and is about 0.5 mm to 3 mm.

The surface layer 14 is laminated on the seal portion 11 in order to provide the seal portion 11 with adhesion resistance to the counterpart members (rear door 4 and garnish 7 in the present embodiment), and is laminated on the seal portion 11 in order to cover foaming unevenness of the base layer 13 to improve appearance with a smooth surface. Therefore, the surface layer 14 is comprised of a resin foam having a plurality of cells 14a therein, the resin foam being obtained by using a resin material as a base material and causing the composition for a surface layer containing a foaming agent and the resin material to foam.

As illustrated in FIG. 4, the cells 14a in the surface layer 14 are open cells in which adjacent cells communicate with each other. As a result, a communication path that communicates from a back surface (base layer 13 side) to a front surface (outside) is formed inside the surface layer 14.

A film thickness of the surface layer 14 is preferably 5 μm to 1 mm, and more preferably 10 μm to 0.3 mm. The film thickness of the surface layer 14 is preferably as thin as possible in order to reduce a pressing force (compression load at which seal portion 11 is pressed) at the time of closing the rear door 4 and to reduce the weight, but when the film thickness is less than 5 m, the surface layer 14 is too thin, surface smoothness may be reduced due to an influence of the foam unevenness of the base layer 13, or the surface layer may be less likely to be formed. On the other hand, when the film thickness exceeds 1 mm, the compression load for pressing the seal portion 11 becomes unnecessarily high, or the communication path is less likely to be formed inside the surface layer 14, and the foaming gas from the base layer 13 is less likely to be released.

The higher a hardness of the surface layer 14, the better the adhesion resistance thereof, but when the hardness is too high, the compression load for pressing the seal portion 11 is increased. Therefore, the hardness of the surface layer 14 is preferably HDA30 to HDA50 in durometer hardness (type A) defined in JIS K 7215.

A specific gravity of the surface layer 14 is preferably as small as possible, and is preferably 0.3 to 0.8, and more preferably 0.5 to 0.7. When the specific gravity of the surface layer 14 is less than 0.3, a foaming ratio (porosity) of the surface layer 14 is too high, and foam unevenness is generated on a surface of the surface layer 14. On the other hand, when the specific gravity of the surface layer 14 exceeds 0.8, there is a concern that the foaming gas from the base layer 13 is difficult to be released to the outside through the surface layer 14.

As the resin material serving as the base material of the surface layer 14, an olefin-based or styrene-based thermoplastic resin or thermoplastic elastomer can be used. Among those, in a case where the EPDM is used as the base material of the base layer 13, the base material of the surface layer 14 is preferably an olefin-based thermoplastic elastomer. When the olefin-based thermoplastic elastomer is used for the surface layer 14 with EPDM of the base layer 13, the EPDM and the olefin-based thermoplastic elastomer are chemically bonded to each other by heat during extrusion molding, an adhesion force between the base layer 13 and the surface layer 14 is high, and the surface layer 14 can be prevented from being peeled off from the base layer 13. Specific examples of the olefin-based thermoplastic elastomer include an olefin-based thermoplastic elastomer containing 10 weight % to 50 weight % of an olefin-based thermoplastic resin such as polypropylene and polyethylene and 20 weight % to 50 weight % of a rubber-based material such as EPDM and SEBS.

The foaming agent to be added to the composition for a surface layer is preferably a chemical foaming agent in which the respective cells 14a tend to form open cells in view of a cell formation principle. As the chemical foaming agent, azo compound-based (ADCA-based) chemical foaming agents, nitroso compound-based (DPT-based) chemical foaming agents, hydrazine compound-based (OBSH-based) chemical foaming agents, sodium bicarbonate-based chemical foaming agents, and composite chemical foaming agents thereof can be used, but among those, the sodium bicarbonate-based chemical foaming agents that generate a relatively small amount of foaming gas is preferable. In a case where a microcapsule is used as the foaming agent, the cells 14a are formed between the capsule and the resin material when the microcapsule expands and contracts. In addition, the foaming agent to be added to the composition for a surface layer and the foaming agent to be added to the composition for a base layer may be different foaming agents or the same foaming agent.

A content of the foaming agent in the composition for a surface layer is 0.1 parts by weight to 3 parts by weight with respect to 100 parts by weight of the resin material. When the content of the foaming agent in the composition for a surface layer is within this range, the cells 14a become open cells. On the other hand, when the content of the foaming agent in the composition for a surface layer is less than 0.1 parts by weight, the number of cells 14a is small, and the foaming gas from the base layer 13 is difficult to be released to the outside through the surface layer 14. In addition, when the content of the foaming agent exceeds 3 parts by weight, the porosity becomes too high, and the foam unevenness is generated on the surface of the surface layer 14.

If necessary, other additives may be added to the composition for a surface layer. For example, the adhesion resistance of the surface layer 14 can be further improved by adding about 1 part by weight to 5 parts by weight of a lubricant with respect to 100 parts by weight of the resin material. As the lubricant, silicone oil that is easily mixed in the composition for a surface layer is preferable, but fluorine oil, or urethane spherical filler, aliphatic acid amide, ultra-high molecular weight polyethylene resin, or the like may be used. In addition, by using a thermoplastic elastomer foam as the surface layer 14, the adhesion resistance and slipperiness can be improved.

### <Producing Method>

The weather strip 10 of the present embodiment is produced by extrusion molding. FIG. 5 schematically illustrates a producing process of the weather strip 10. First, the composition for a base layer and the composition for a surface layer are extrusion-molded into a predetermined shape using an extrusion molding machine 19. The extrusion molding machine 19 is configured by an extruder 20 for the composition for a base layer, an extruder 21 for the composition for a surface layer, and a molding die 22 having a die 22a of a predetermined shape inside, and the extruder 20 and the extruder 21 are connected to the molding die 22, respectively. In addition, the composition for a base layer and the composition for a surface layer are simultaneously supplied to the molding die 22 from the extruder 20 and the extruder 21, respectively, and the base layer 13 and the surface layer 14 are co-extruded (extrusion molding step). As a result, a continuous weather strip intermediate in which the base layer 13 and the surface layer 14 are already laminated and a cross-sectional shape of the weather strip 10 is continuous in a longitudinal direction is extruded from the extrusion molding machine 19.

Here, for example, in a case where the surface layer 14 produced in a separate process is applied after the base layer 13 is extrusion molded, a position of the surface layer 14 may be shifted with respect to the base layer 13 or the surface layer 14 may be peeled off from the base layer 13. In contrast, in the present embodiment, since the base layer 13 and the surface layer 14 are co-extruded in a laminated state, the surface layer 14 can be accurately laminated at a predetermined position without being displaced, and adhesion between the base layer 13 and the surface layer 14 can be improved.

The die 22a in the molding die 22 is set to a temperature at which the rubber material in the composition for a base layer is softened but not vulcanized and the foaming agent is not foamed in the vicinity where the composition for a base layer extruded from the extruder 20 passes through the die 22a. On the other hand, a temperature in the vicinity where the composition for a surface layer extruded from the extruder 21 passes through is set to, by a heater, a temperature higher than that in the vicinity where the composition for a base layer passes through, and is set to a temperature at which the resin material is softened and the foaming agent is foamed. As a result, in the extrusion molding step, a weather strip intermediate in which the foaming agent in the surface layer 14 is foamed but the foaming agent in the base layer 13 is not foamed is extruded from the extrusion molding machine 19. The foaming agent contained in the composition for a surface layer is foamed when the weather strip intermediate is extruded from the extrusion molding machine 19 and released to the outside. In this case, the respective cells 14a in the surface layer 14 are open cells.

Next, the weather strip intermediate is supplied to the heating bath 23, and the weather strip intermediate is sequentially heated (heating step). The heating bath 23 is a long tunnel-shaped heating oven, and an entire length thereof ranges from several meters to several tens of meters. A heating method in the heating bath 23 may be, for example, hot air heating by combustion gas or the like, microwave heating, or both.

A set temperature of the heating bath 23 is set to a temperature at which the base layer 13 is vulcanized and the foaming agent is foamed. Accordingly, as the weather strip intermediate passes through the heating bath 23, the foaming agent in the base layer 13 is foamed, and foaming gas is generated from the base layer 13. In this case, in the seal portion 11, foaming gas generated from an inner peripheral portion of the base layer 13 flows out to a hollow space of the seal portion 11, and foaming gas generated from an outer peripheral portion thereof flows out to the surface layer 14 side. However, since the open cells 14a serving as the communication path that communicates from the base layer 13 side to the outside are formed in the surface layer 14, the foaming gas from the base layer 13 can be released to the outside through the open cells 14a. On the other hand, the foaming gas accumulated in the hollow space of the seal portion 11 may be released to the outside by piercing a needle into the seal portion 11 at predetermined intervals in the longitudinal direction to form a hole penetrating the base layer 13 and the surface layer 14 in a thickness direction, or may be released to the outside by opening an end portion in the longitudinal direction in a subsequent cutting step. Since the entire attachment portion 12 is exposed to the outside, the foaming gas generated from the attachment portion 12 is released to the outside without being retained. Through the heating step, vulcanization and foaming of the base layer 13 and the attachment portion 12 are completed, and the weather strip intermediate becomes a continuous weather strip 10.

Then, the weather strip 10 subjected to the heating step is supplied to a cooling bath 24, the base layer 13 is cooled and solidified, and the surface layer 14 is hardened to fix a shape of the weather strip 10. As the cooling bath 24, typically a water bath may be used. Next, after the weather strip 10 is supplied to a draining machine 25 and water is removed, the weather strip 10 is hauled by a hauling machine 26, and finally, the continuous weather strip 10 is cut to have a predetermined length by a cutting machine 27 to be commercially available.

Although the representative embodiment of the present invention has been described above, the present invention is not limited thereto, and in particular, shapes of the seal portion 11 and the attachment portion 12, that is, an overall shape of the weather strip 10 can be variously changed according to an applied location.

### EXAMPLES

Examples and comparative examples in which the present invention is evaluated and tested will be described. In the examples and the comparative examples, a simulated weather strip formed of only a hollow seal portion was produced for convenience for evaluation test. A formulation of compositions used in the examples and the comparative examples and physical properties of a surface layer are shown in Table 1. The physical properties of the surface layer were measured by producing only the surface layer by single extrusion.

TABLE 1

| | | | | Comparative | Comparative |
|---|---|---|---|---|---|
| | | Example 1 | Example 2 | Example 1 | Example 2 |
| Composition for base layer | Rubber material | 100 | 100 | 100 | 100 |
| (parts by weight) | Foaming agent | 2.5 | 2.5 | 2.5 | 2.5 |
| Composition for surface layer | Resin material | 100 | 100 | 100 | 100 |
| (parts by weight) | Foaming agent | 0.5 | 2 | 0.01 | 5 |

| | | | | |
|---|---|---|---|---|
| Thickness of surface layer (mm) | 0.1 | 0.1 | 0.1 | 0.1 |
| Specific gravity of surface layer | 0.7 | 0.5 | 0.9 | 0.2 |

As materials shown in Table 1, the following materials were used.
Rubber material: EPDM
Foaming agent for base layer: OBSH-based chemical foaming agent (“Neothlene” manufactured by EIWA CHEMICAL IND. CO., LTD.)
Resin material: olefin-based thermoplastic elastomer (“Milastomer” manufactured by Mitsui Chemicals, Inc.)
Foaming agent for surface layer: sodium bicarbonate-based chemical foaming agent (“Polythlene” manufactured by EIWA CHEMICAL IND. CO., LTD.)

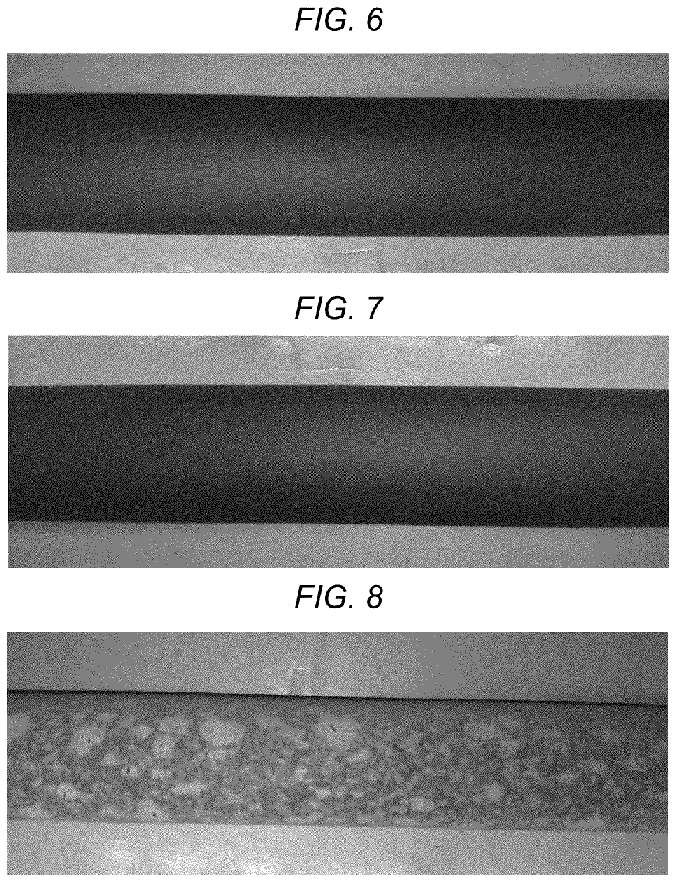

In each of the examples and the comparative examples, extrusion molding was performed under the following conditions. A composition for a base layer and a composition for a surface layer were supplied to the same extrusion molding machine from an extruder set to 50° C. and an extruder set to 200° C., respectively, and were co-extruded to cause a foaming agent in the composition for a surface layer to foam, and then supplied to a heating bath set to 200° C. to perform vulcanization and cause a foaming agent in the composition for a base layer to foam. Thereafter, through cooling, draining, and cutting, simulated weather strips for the examples and the comparative examples were obtained. In addition, appearance of each of the examples and the comparative examples was visually evaluated. Appearance photographs thereof are illustrated in FIGS. 6 to 9.

As illustrated in FIGS. 6 and 7, in Examples 1 and 2, a surface of the surface layer was smooth and the appearance thereof was good. According to the above, it is understood that in Examples 1 and 2, cells in the surface layer are open cells, and foaming gas from the base layer is released to the outside through the open cells.

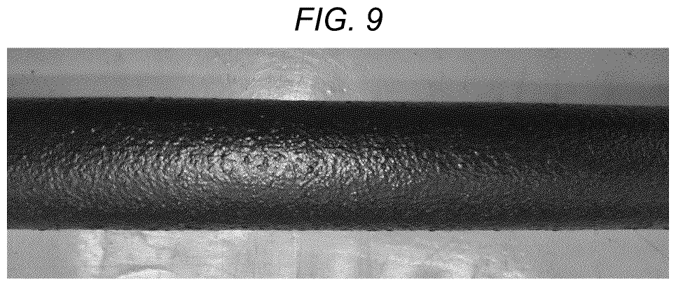

In contrast, as illustrated in FIG. 8, in Comparative Example 1, foaming gas remained at an interface between the base layer and the surface layer. This is because no open cells are formed inside the surface layer, and there is no escape portion for the foaming gas generated from the base layer. The surface layer in FIG. 8 is not colored to facilitate observation of the foaming gas. In addition, as illustrated in FIG. 9, in Comparative Example 2, foam unevenness was generated on a surface of the surface layer, and the appearance thereof was poor. This is because a content of the foaming agent in the composition for a surface layer was too large.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

### REFERENCE SIGNS LIST

1 vehicle
2 car body panel
3 front door
4 rear door
5 quarter window
6 quarter window molding
7 garnish
10 weather strip
11 seal portion
12 attachment portion
13 base layer
13a cell
14 surface layer
14a cell
19 extrusion molding machine
20 and 21 extruder
22 molding die
22a die
23 heating bath
24 cooling bath
25 draining machine
26 hauling machine
27 cutting machine

What is claimed is:

1. A method for producing a weather strip,
the weather strip having a seal portion that is configured to be sandwiched between a periphery of a car body opening part and a door body capable of closing the car body opening part and seal a space therebetween,
the seal portion including abase layer that forms a shape of the seal portion and a surface layer that covers at least a part of an outer surface of the base layer,
the base layer being comprised of a rubber foam obtained by causing a composition for a base layer containing a foaming agent and a rubber material to foam,
the surface layer being comprised of a resin foam obtained by causing a composition for a surface layer containing a foaming agent and a resin material to foam,
the method comprising:
extrusion molding of simultaneously co-extruding the composition for a base layer and the composition for a surface layer; and
heating of a weather strip intermediate extruded in the extrusion molding step, wherein
the foaming agent in the composition for a surface layer is caused to foam in the extrusion molding, and
the foaming agent in the composition for a base layer is caused to foam in the heating.

2. The method for producing a weather strip according to claim 1, wherein
the composition for a surface layer contains 0.1 parts by weight to 3 parts by weight of the foaming agent with respect to 100 parts by weight of the resin material.

3. The method for producing a weather strip according to claim 1, wherein
the rubber material in the composition for a base layer is an ethylene propylene diene copolymer, and
the resin material in the composition for a surface layer is an olefin-based thermoplastic elastomer.

4. The method for producing a weather strip according to claim 1, wherein
the composition for a surface layer contains a silicone oil.

5. The method for producing a weather strip according to claim 1, wherein
the foaming agent in the composition for a surface layer is a chemical foaming agent.

6. A weather strip, which has a seal portion that is configured to be sandwiched between a periphery of a car body opening part and a door body capable of closing the car body opening part and seal a space therebetween, wherein
the seal portion includes a base layer that forms a shape of the seal portion and a surface layer that covers at least a part of an outer surface of the base layer,
the base layer is comprised of a rubber foam body obtained by causing a rubber material to foam,
the surface layer is comprised of a resin foam body obtained by causing a resin material to foam, and
the surface layer includes open cells, in which adjacent cells communicate with each other.

7. The weather strip according to claim 6, wherein
the surface layer contains a silicone oil.
